(19) United States
(12) Patent Application Publication
(10) Pub. No.: US 2023/0271887 A1
(43) Pub. Date: Aug. 31, 2023

(54) Process for Creating Carbon-Carbon Composite Structural Parts by 3D Printing

(71) Applicant: Robert Reynolds Tipton, Honolulu, HI (US)

(72) Inventor: Robert Reynolds Tipton, Honolulu, HI (US)

(21) Appl. No.: 17/683,319

(22) Filed: Feb. 28, 2022

(51) Int. Cl. C04B 35/83; B29C 71/02; B33Y 70/10; B33Y 40/20; C04B 35/64

(52) U.S. Cl. CPC C04B 35/83; B29C 71/02; B33Y 70/10; B33Y 40/20; C04B 35/64; B29C 64/153

(57) ABSTRACT

A process for 3D printing Carbon-Carbon Composite precursors and affordably pyrolyzing and graphitizing them to form structural parts suitable for aircraft primary structure (or other applications) at costs competitive with machined metal of fiber-resin parts.

The process described in this application produces Carbon-Carbon Composite precursors using 3D printing technology. The primary benefit of this process is substantial reduction in cost and production times for parts of similar properties made of metal or other composites. It is important to distinguish Carbon-Carbon Composites from Carbon-Resin Composites. Carbon-carbon Composites are graphite or Fullerene fibers or whiskers in a graphite matrix and provide substantially better mechanical properties. The aerospace industry has been seeking a method for producing parts of this type at low cost for over 50 years. If such parts were available, at competitive costs, they would reduce the weight, fuel consumption and range of all types of air vehicles.

This patent application incorporates provisional patent application No. 63/156,334 and inherits its filing date of Mar. 3, 2021.

The process described in this application uses a 3D printing base material composed of a thermoplastic with graphite fiber or whisker reinforcement, fabricates 3D printed parts of this material into the desired shape, pyrolyzes/carbonizes them and then graphitizes the precursor into a final part. The process bypasses the creation of the mold, re-injection and/or vapor deposition steps that are required using current processes for creating Carbon-Carbon Composites.

Current processes for creating Carbon-Carbon Composites form the precursor parts by means of injection molding. To achieve high strength and minimize mass loss during pyrolization, the base material should have the highest possible particle volume density. Because it is not possible to force material with extremely high particle volume density through the mold channels and avoid voids, the particle volume density is extremely limited. Since the base material described in this process isn't injection molded, it can have a much higher particle volume density.

The benefits of Carbon-Carbon Composites are well known; high strength, high stiffness, low density and extremely high temperature resistance. Its detriments are also well known.; high cost, combustibility, dangerous processing and embrittlement. Its properties can be improved further by using graphite whiskers in place of graphite fibers.

In the early 1980s it was widely believed that Carbon-Carbon Composites would be the material that changed the world. Strength and stiffness are not the most critical attributes for high performance vehicles. Specific strength and stiffness are. Specific strength and stiffness are the usual values divided by the density of the material. Basically, how much strength and stiffness do you get per kilogram of material. Carbon-Carbon Composites have specific strength and stiffness 2 to 10 times higher than the best structural materials available in 2021. By designing them to be porous, as described later, the specific strength arid stiffness of the final parts could be 20 times higher than present materials or more.

Today, the value of a 100% carbon structure which can be produced using 100% sustainable materials and energy which can be sequestered upon the end of its useful life makes this material of even greater value. Such structures would not only be CO₂ neutral, but CO₂ negative.

The factors that make current Carbon-Carbon Composite production too costly are:
Base parts are made by injection molding of carbon fiber impregnated plastics. Since high performance vehicle structures are produced in low volume, there are insufficient ‘shots’ from the mold to defer the high cost of a precision mold.
Because injection molding requires low volume density of fiber to achieve adequate flow and mold filling, a large fraction of the matrix is charred away during pyrolysis. This requires multiple injections of the matrix to compensate for the lost material.
The parts are densified by vapor depositing additional carbon using high temperature acetylene gas. Parts produced by the process described in this application would be inherently denser requiring less densification. In many applications densification can be bypassed entirely.

Selective Laser Sintering (SLS) of a plastic such as Nylon or Polyacrylonitrile filled with very high volume density of chopped carbon fibers or graphite whiskers allows producing the precursor parts with much higher particle volume density. This reduces the volume density of the matrix thereby reducing the volume lost during pyrolysis. For structural parts which do need to be air tight, this means densification may not be required. While specific fiber or whisker densities have yet to be determined, it is possible that densities of 80% or higher can be achieved.

While this patent application covers 3D printing of graphite reinforced thermoplastics, including methods such as Filament Deposition, methods which fuse plastic particles such as SLS do not require the molten composite material be forced through an orifice. Therefore particle fusing methods can have the greatest volume density of particles.

One drawback of 3D printing is the temperature variations during the printing process and the subsequent warping and deformations of the parts. The process described in this application makes use of thermoplastics with very high volume density of graphite which have a very low coefficient of thermal expansion. This results in greatly reduced warping and deformation. The process described in this process will result in much more precise parts which can achieve the tight tolerances required for high performance vehicle structures.

Current 3D printing methods often suffer from alignment problems which occur when laying down thousands of layers of material. One solution to this is to add a machine vision and inspection step after each layer is printed followed by a correction pass. This additional step is not cost effective for low cost consumer parts, but would be cost effective for structural parts. This application includes this optional step as part of the process to achieve parts of adequate precision. 3D printing is also capable of creating complex shapes with engineered voids—such as honeycombs or lattices.

Utilizing a honeycomb or lattice overcomes one of Carbon-Carbon Composites' other weaknesses, excessively thin walls. Because Carbon-Carbon Composites are so strong and stiff, very little material is required to achieve required properties. Unfortunately when a material becomes too thin it looses strength and stiffness due to its geometry. It also becomes very easy to puncture or fracture. By distributing the material in an open space geometry, adequate part thickness is achieved and the density is reduced even further.

3D printing a porous structure increases the specific properties by reducing its average density. This is especially important for aircraft applications because a change in weight of the structure of 5% can result in a 10% to 30% reduction in total vehicle weight. This mathematical legerdemain occurs because less fuel is required during flight which in turn requires less structure which reduces its weight, which in turn requires less fuel. This cycle does eventually converge, with the result of dramatically lighter aircraft—which use dramatically less fuel.

Almost all of the recent advances in aircraft have been due to advances in material science resulting in reduced weight. Boeing and other manufacturers are approaching the performance limits of their available materials.

The ability to affordably fabricate aircraft made predominately of Carbon-Carbon Composites would not only dramatically reduce worldwide CO₂ emissions, reduce recurring costs of fuel and reduce noise levels by using smaller engines—it would stimulate the entire aerospace sector with demand for vehicles manufactured using this new process. Frequently, technological breakthroughs in aerospace transfer rapidly into other sectors such as automotive, marine, energy and rail. If this pattern were to repeat, it would stimulate a new manufacturing boom while reducing global CO₂ output.

Steps in the process
1. Prepare a powder consisting of a thermoplastic matrix with fine particles of graphite fibers, graphite whisker or Fullerenes. The particle size would vary by application and is not critical to this patent application.
   1. The particle density of the powder should be has high as possible while providing adequate fusing of the particles. While exact ratios are yet to be determined, it is anticipated they will be between 60% and 100% by volume. This figure is provided for reference and is not critical to this patent application,
2. The powder is fused using a process such as Selective Laser Sintering or selective adhesive bonding to form the final part.
   1. If required each step in the fusing process is inspected using machine vision to adaptively correct the part to achieve adequate tolerances.
3. The excess powder is removed from the part.
4. The part is exposed to high temperatures and the hydrogen in the thermoplastic is ‘charred’ off to leave a pure carbon. This material is referred to a coke. This part of the process is called pyrolysis or carbonization.
5. After pyrolysis, the part(s) are placed in high temperature, non-oxidizing kiln to allow the disorganized carbon in the coke to crystallize into graphite. This part of the process is called graphitization.
   The temperature at which graphitization takes place determines the limit temperature of the final part(s). While high temperatures are required for high temperature applications such as the leading edge tiles on the Space Shuttle, these temperatures are not required for structural parts.
   The time the part(s) remain in the kiln increases the length of the newly formed graphite crystals. Using very fine particles such as whiskers or Fullerenes increases the surface are for crystal formation.
6. The parts are cooled.
7. If required, the parts may be densified by vapor deposition of carbon.

### Prior art

U.S. Pat. No. 10,022,890 Jul. 17, 2018 In situ carbonization of a resin to form a carbon-carbon composite

U.S. Pat. No. 10,302,163 May 28, 2019 Carbon-carbon composite component with antioxidant coating

U.S. Pat. No. 10,131,113 Nov. 20, 2018 Multilayered carbon-carbon composite

There is little prior art in this area and most of it has focused on using 3D printing technology to directly form Carbon-Carbon Composites. This process describes a much less aggressive approach of 3D printing a graphite reinforced thermoplastic part mid processing it by more traditional methods.

I claim:

1-6. (canceled)

7. A process for producing carbon-carbon composite material comprised of
7.1. Forming a thermoplastic powder containing carbon whiskers or carbon fibers where the fiber accounts for more than ⅓ of the powder's volume and the powder has a coefficient of thermal expansion near zero.
7.2. Fusing that powder into a solid object using the 3D Printing process of Selective Laser Sintering.
7.3. Pyrolyzing the restating object into a coke reinforced with carbon whiskers/fibers.
7.4. Graphitizing the reinforced coke into a part made of carbon whiskers/fibers in a crystallized carbon matrix.

8. A process for producing carbon-carbon composite material comprised of
8.1. Starting with a powder formed of carbon whiskers
8.2. Using an adhesive which can be pyrolyzed into carbon (a coke)
8.3. Using the adhesive in step 2.2 and the 3D printing process of Selective Adhesive Bonding to form a solid object.
8.4. Pyrolyzing the resulting object into a coke reinforced with carbon whiskers/fibers.
8.5. Graphitizing the reinforced coke into a part made of carbon whiskers/fibers in a crystallized carbon matrix.
